(19) United States
(12) Patent Application Publication
(10) Pub. No.: US 2016/0269349 A1
(43) Pub. Date: Sep. 15, 2016

(54) SYSTEM AND METHOD FOR ORCHESTRATING AND CORRELATING MULTIPLE SOFTWARE-CONTROLLED COLLABORATIVE SESSIONS THROUGH A UNIFIED CONVERSATIONAL INTERFACE

(71) Applicant: General Electric Company, Schenectady, NY (US)

(72) Inventors: Joseph William Bolinger, San Ramon, CA (US); Piyush C. Modi, San Ramon, CA (US); Bo Yu, San Ramon, CA (US); Aravind Kumar Mikkilineni, San Ramon, CA (US); Yoshifumi Nishida, San Ramon, CA (US)

(21) Appl. No.: 14/656,193

(22) Filed: Mar. 12, 2015

(51) Int. Cl. H04L 12/58; H04L 29/08

(52) U.S. Cl. CPC H04L 51/36; H04L 67/1087; H04L 51/10; H04L 51/046

(57) ABSTRACT

A method for correlating multiple collaborative sessions occurring on multiple single-modality systems includes creating a respective collaborative element containing metadata about each respective collaborative session, associating each collaborative element with a corresponding collaborative conversation, providing an overlaying control plane across the multiple single-modality systems, computing and storing conversational context of user actions within the collaborative sessions. The method further includes performing data aggregation of data within the multiple collaborative sessions, publishing one or more messages providing information regarding changes in the multiple collaborative sessions, switching modalities by entities participating in one or more of the multiple collaborative sessions, wherein the entities can follow session conversations by accessing the published one or more messages, and embedding a link in a single-modality system user interface referring to a previous session. A non-transitory computer readable medium and a system are also disclosed.

### BACKGROUND

Collaborative systems play increasingly important roles in the personal and professional lives of individuals. Collaboration services (e.g., video conferencing, e-mail, social networking, screen sharing, instant messaging, and document sharing) can now be found in or around nearly all modern software applications. In some cases, these kinds of underlying services can be seamlessly embedded directly within business applications and consumer software products.

Collaborative systems are huge in scale and complexity. They are composed of vast networks of loosely connected software applications and services that collectively support complex work practices. It is difficult for individual software components to support such complex kinds of work alone because collaborative group processes tend to be highly dynamic and unpredictable. Users tend to rely on a suite of software tools to effectively collaborate with others rather than monolithic applications that have been purpose built with all of the idiosyncratic details of their working environment in mind.

This kind of federation can scatter information about how individuals are interacting with one another across a network of systems. Metadata about how people are collaborating, and about the artifacts that they are manipulating in the process, can become distributed across all of the individual elements that make up the network. Consolidating and processing this kind of metadata has a tremendous amount of potential.

Collecting and consuming this kind of metadata is challenging for at least two distinct reasons. Firstly, it is challenging because there is no widely accepted definition of what kinds of information this metadata should, or should not, include. Secondly, there are no well-known architectural patterns that define how this data should be distributed and propagated across a loosely coupled set of collaborative software services so that each individual service can adapt itself to the overall state of affairs.

### BRIEF DESCRIPTION OF THE DRAWINGS

FIG. 1 depicts an interaction history of a conversation in accordance with some embodiments;

FIG. 2 depicts a schema for the conversation interaction history of FIG. 1 in accordance with some embodiments;

FIG. 3 depicts an architecture of a conversational system in accordance with some embodiments;

FIG. 4 depicts a conversation interaction history in accordance with some embodiments; and

FIGS. 5A-5B depict a process for correlating multiple collaborative sessions occurring on multiple single-modality systems in accordance with some embodiments.

### DESCRIPTION

In accordance with embodiments, systems and methods provide federated collaboration services that can adapt to and expose information about the state of emergent “conversations” that people engage in as they interact through collaborative services over time. For example, embodying systems and methods can be used to build more intelligent and proactive services, which can dynamically adjust their characteristics based on the context of ongoing collaborations. In one implementation, for example, e-mail servers could re-route incoming mail, and/or convert it to voice and/or text messages, depending on, for example, what the recipient is currently doing, with whom, or why. Document-sharing services could alter their default security settings based on, for example, the relationship between parties, their respective locations, or the type of content that is being shared, etc.

Collaborative systems can provide better support for on-line collaboration when they are able to understand and react to the surrounding context. It is understood that context is dependent on the domain of work that the system supports (e.g., lawyers collaborating on a case versus students working together on a paper). Nonetheless, it is possible to define certain limited types of context that are relatively generic across domains, which can be used as an underlying meta-model to define the state, or context, of a federated collaborative system.

In accordance with embodiments, one such type of context is defined as the “conversational” context of the system. Embodying systems and methods provide a generalized architecture for conversation-based systems that leverages this additional contextual data to better support collaborative work.

The concept of a conversational context is motivated by observing that collaborative technology is most often used in practice as a network of loosely coupled software services. Each of the individual services may excel at supporting specific functions or tasks within a larger group process, but cannot fully support that larger process alone. Each one of these individual systems can be thought of as offering a particular “modality,” or means of collaboration, that is useful for carrying out a variety of simple tasks. For example, e-mail is a good modality for tasks that require exchanging relatively long and asynchronous messages. Users often need to switch back and forth between modalities in order to collaboratively complete a meaningful chunk of work in their domain of practice.

By way of example, research report coauthors might need to first exchange information through messaging or voice channels, then share some preliminary documents, and later communicate status updates through activity or message streams. Every time a user engages with another user though a particular modality is referred to as engaging in, or altering, the state of a session. An emergent series of sessions over time and across various modalities is referred to as the interaction history of a conversation.

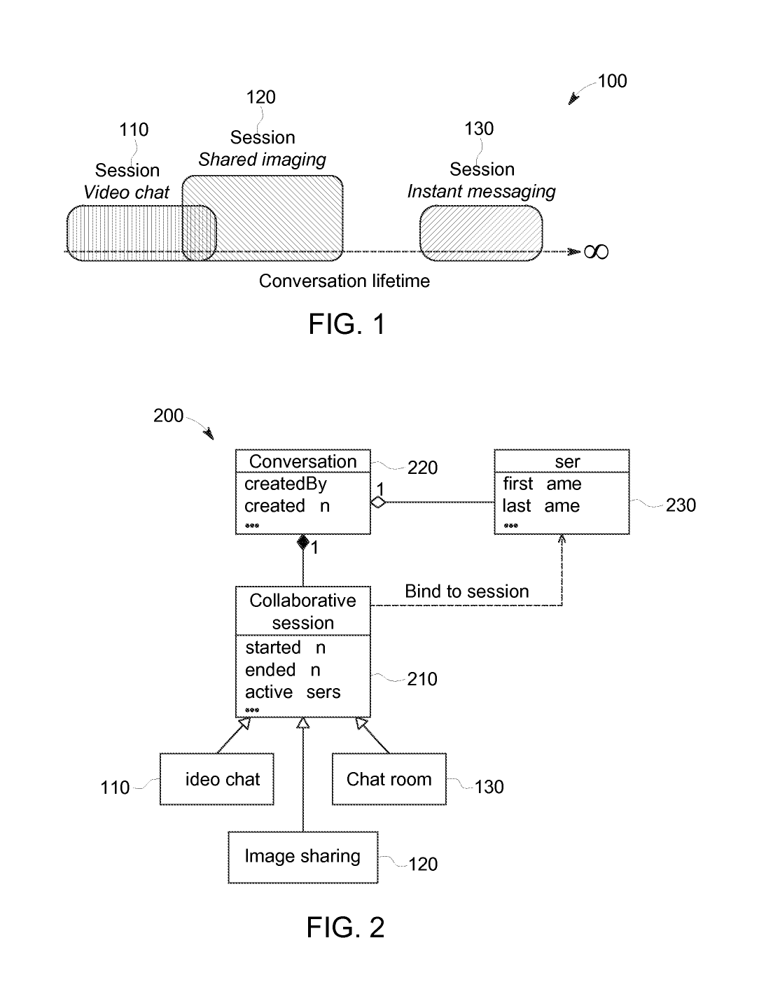

FIG. 1 depicts an interaction history of conversation 100 in accordance with some embodiments. Conversation 100 includes session 110 which is conducted via a video chat modality. During session 110 the participants also initiated session 120, where images were shared. At some later time, conversation 100 was continued by chat-room instant messaging between participants of conversation 100 during session 130. Conversation 100 can be open-ended in that later sessions can become part of the interaction history.

As used herein, the term “conversation” is representative of emergent artifacts of collaboration between participants, and capturing the by-products of articulation work that drives complex and knowledge-driven types of work. As opposed to activities, tasks and cases that are driven by a common objective or goal.

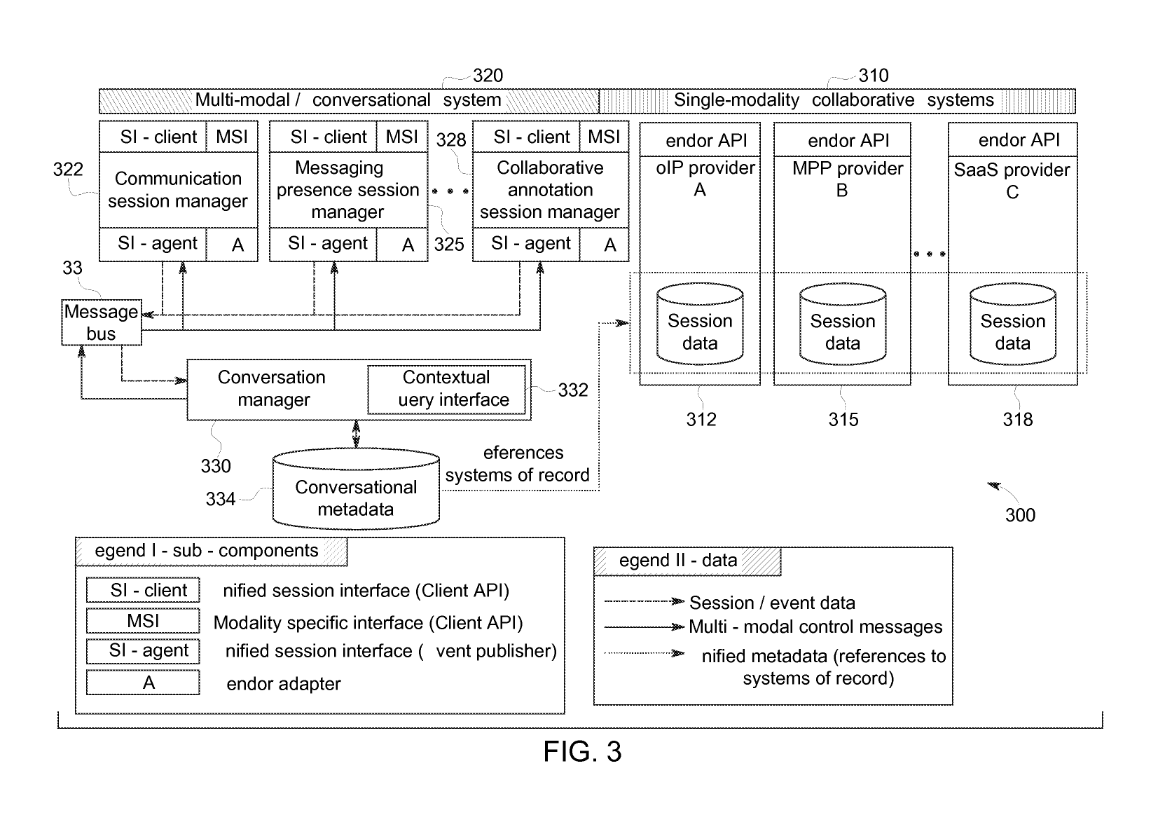

FIG. 2 depicts schema 200 for the interaction history of conversation 100 in accordance with some embodiments. Schema 200 includes one or more of collaborative element 210, which contains metadata regarding each collaborative session—for example, a time-stamp of when the collaborative session was first initiated, when the collaborative session ended, its participants, etc. In some implementations, a collaborative element can be created for each of video chat session 110, image sharing session 120, and chat-room instant messaging session 130. Conversation element 220 can include metadata regarding the conversation itself—for example, the user-id of its creator, when the conversation was created, a time-stamp for each collaborative session, etc. User element 230 can contain information regarding each participant of the conversation—for example, user-id, name, organization, which sessions were joined by the user, etc.

Given schema 200 that defines the conversational context of a system, a canonical (e.g., rule-based) model for a system that produces and consumes this data can be defined. At a high level, a conversation-based system is one that orchestrates the collective behavior of any number of functionally independent sub-systems (i.e., the modalities) based on users' interaction histories across all of the sub-systems (i.e., the collaborative sessions), where the interaction history is represented by the schema depicted in FIG. 2. Naturally, schema 200 is for discussion purposes and in a concrete realization of such a system the conversational meta-model could be much more detailed, formalized through ontology or domain specific languages, etc. However, this schema model captures the representative constructs that are present.

In accordance with embodiments, a conversation-based system is a federated network of collaborative services, or “session providers,” each of which publishes messages about how the sessions that they are managing are changing over time. This publication is done using a standardized, conversation-based meta-model so that any entities that are listening to these messages, including themselves, can follow conversations as they switch modalities.

To follow conversations from modality to modality, a conversation-based system includes the capability for sessions to become associated with a corresponding conversation—i.e., an explicit and formalized way of calculating or otherwise determining this relationship. This mechanism for relating sessions and conversations in a conversation-based system can be implemented in a variety of ways. In accordance with embodiments, the relational element is done consistently across a network of collaborative services so that an accurate representation of ongoing conversations can be maintained.

An embodying conversational system includes a standardized data model that service providers are expected to emit as they operate; and a published (or well known) set of rules and/or algorithms that can map a larger set of sessions onto a smaller set of conversations. A conversational system that includes these two conditions can expose some amount of contextual metadata that reveals something about the relationships between individual sessions. Even without any additional domain specific knowledge this kind of metadata could be used to build more intelligent services.

By way of example, consider the conversation interaction history depicted in FIG. 1. During Session 130 a user might be sending instant messages via an instant messaging application to his or her colleagues that refer to the images that they were sharing previously during Session 120. In accordance with embodiments, with this contextual metadata, a set of links could be embedded somewhere in the instant messaging client's user interface (UI) that refer back to the previous sessions, but only for this particular chat room (i.e., it would not appear during other chat sessions even if the same colleagues were also involved).

These embedded links could make it easier for the collaborators to switch between the various software tools that they are using to work together on this particular problem and at that particular moment in time. Such a unified application switcher could be implemented in nearly any collaborative client application, regardless of its modality, given only a minimal amount of conversational metadata and without tightly coupling any of the individual client tools.

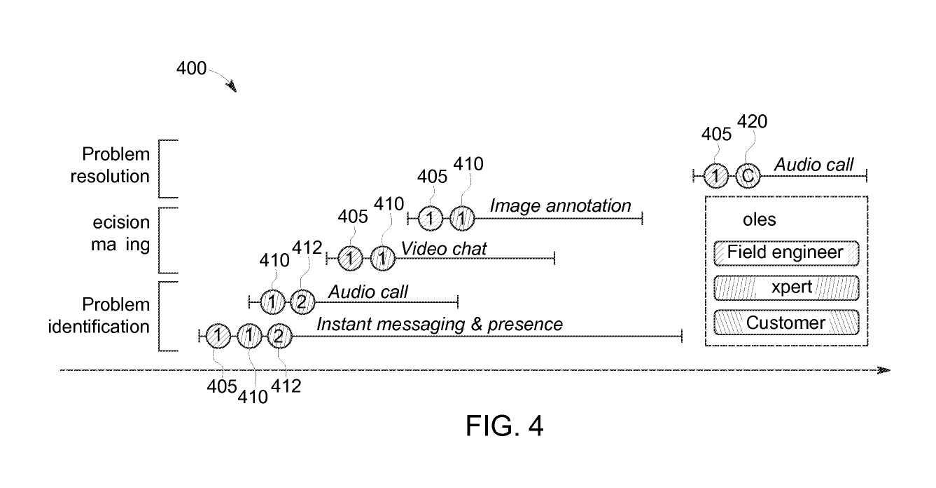

FIG. 3 depicts canonical system architecture 300 of a conversational system in accordance with some embodiments. Canonical system architecture 300 represents a detailed design pattern that outlines how a conversational system could be realized in some implementations. Embodying systems and methods are not so limited, the focus of this representative architecture is on enumerating the elements that make a conversation-based collaborative system.

The general architecture of an embodying conversational system can include two major sets of entities—single-modality collaborative system 310 and multi-modal conversational system 320. Single-modality collaborative system 310 is a set of functionally independent sub-systems that provide various collaboration services (i.e., the session providers). These can be any set of services that are not already integrated, such as a video conferencing appliance and a social media website. Each of these systems is referred to as a single-modality collaborative system because they allow users to interact with other users or the system itself in a specific way (i.e., the modality). Such single-modality systems can include, but are not limited to, VoIP system 312, Extensible Messaging and Presence Protocol (XMPP) system 315, and Software as a Service (SaaS) system 318. Each of these single-modality systems can include a proprietary vendor API and data store.

For example, in the case of a video conferencing system and a social media website the modalities are through video chat sessions and via activity feeds, respectively. These systems are responsible for maintaining in their respective data stores modality-specific data about users and their interactions over time, known as their “sessions,” and managing the lifecycle of these modality-specific sessions (i.e., a single chat session, videoconference, etc.).

Multi-modal conversational system 320 includes multi-modal conversation manager 330 and a set of modality-specific session managers—for example, but not limited to, communication session manager 322, messaging and presence session manager 325, and collaborative annotation session manager 328. Session managers act as an overlaying control plane across all of the single-modality systems and as a data aggregation device.

Each session manager is responsible for controlling a single type of session, such as instant messaging, which is ultimately provided by one of the underlying single-modality systems. Session managers are specialized proxies that delegate the majority of their responsibilities to their single-modality counterpart(s) that manage the lifecycle of the underling services. The session manager can also contain additional logic for coordinating cross-modal system behaviors. To achieve this, each session manager can include the following sub-components: a unified session interface (USI)-client, a USI-Agent, a modality specific interface (MSI), and a vendor adapter (VA).

Unified Session Interface (USI)-Client

In accordance with embodiments, each session manager exposes a canonical set of generic application programming interfaces (API) through its USI-Client that can be used to control any kind of session regardless of its modality. This ensures that any single-modality standards, vendor APIs, or protocols (XMPP, SIP, etc.) are hidden from clients of the system and ensures that any client can control any session, to some degree, regardless of its modality through the USI (i.e., enabling forward/reverse compatibility).

For example, in accordance with one implementation session managers could expose the operations listed in Table I.

TABLE I
USI Client Operations

| Name | Description |
|---|---|
| Start | Begin a session |
| End | End a session |
| Join | Join a user to an ongoing session |
| Leave | Remove a user from an ongoing session |
| List | Get a list of all users that are in a session |
| Tag | Associate a given session with a conversation |

Unified Session Interface (USI)-Agent

In accordance with embodiments, the session managers can report session life-cycle events to conversation manager 330 via a messaging infrastructure (e.g., messaging bus 336) to keep the conversation manager informed of the state of all sessions across modalities. Each respective session manager obtains information on these events from the single-modality systems via the session manager's respective USI-Agent.

Conversation manager 330 receives the information and processes it to compute, analyze, and/or determine the conversational context of user actions. The conversation manager does this by grouping discrete events from multiple session managers into logical conversations according to pre-determined policies, algorithms, programs, and/or through explicit mechanisms such as the tag operation enumerated in Table I. The conversational manager can store the information in conversational metadata data store 334. This conversational data store can also reference information located in the respective session data stores of the single-modality systems.

In accordance with embodiments, the event information recorded and/or processed by the conversation manager can include a unified set of common events such as the operations listed in the previous section. For example, the USI-Agents can report when sessions start, end, and/or are changed in some way (i.e., a user in a session does something).

The USI-Agent and the USI-Client components of the conversation-based system allow any client to understand the conversation interaction history and to control other modalities, at least to some degree. In other words the USIs serve as a foundational language for federated services to interoperate.

Session managers may also expose a set of APIs to their respective MSIs that are specific to the modality that they are responsible for managing. This allows them to give clients of the system more fine grained control of individual sessions and broadcast specialized events that are not part of the USI. For example, Messaging & Presence Session Manager 325 might expose an API in its MSI to send a message to all of the users in a given session. Unlike the USI, the MSI may or may not require the client to understand various vendor APIs or protocol standards and is entirely optional.

In some implementations of a conversation-based system, clients may make requests directly to the underlying single-modality subsystems instead of indirectly accessing them through an MSI. In other cases, the MSI may be present and act as an adapter so that the client is not directly exposed to the underlying sub-system. In either case, the session managers must have some visibility into how a client is interacting within a modality so that it can perform its orchestration duties and keep the conversation manager informed of key events.

Session managers receive requests from system clients through a combination of the USI, MSI, and/or through direct integration with one or more of the single-modality subsystems. The session manager then decides how to satisfy the requests in a conversational context. To do so, session managers listen for control messages from conversation manager 330, which can access information on the global conversational context (i.e., the state of all sessions across modalities). Using these sources of inputs, the session managers control the lifecycle of the individual sessions by delegating to the underlying set of single-modality systems.

Session managers can communicate with the external single-modality systems through vendor adapter APIs. Vendor adapters encapsulate any integration logic associated with these APIs so that the conversational system, as a whole, can be deployed with varying sets of underlying single-modality systems.

Conversation manager 330 is responsible for maintaining the history of conversations as users interact through the system over time. It listens for messages from each of the session managers and correlates session events with ongoing conversations using a set of rules or conventions. This allows the conversation manager to perform two critical roles within the overall system: contextual queries via a contextual query interface, and multi-modal session control.

The conversation manager exposes contextual query interface 332 that session managers, and/or external systems, can use to access the contextual metadata maintained in conversational metadata data store 334. As shown in FIG. 3, the query interface can reference data that is housed in the underlying single-modality subsystems. The query interface can shield clients from lower-level implementation details and common systems integration concerns, such as determining a user's unique identifier in each of the sub-systems.

The conversation manager can also leverage the contextual metadata data repository to send multi-modal session control messages to session managers. For example, it may use a set of rules to instruct session managers to reconfigure themselves, inject data into or modify ongoing sessions, etc. based on changes in the system's overall conversational state.

Each session manager can integrate with existing, off-the-self, single-modality systems that support collaboration among users and funnel metadata about these interactions to the conversation manager. The conversation manager can aggregate this data, analyze it, and make decisions about how individual sessions should be adjusted based on the global state of the larger set of users' past and present conversations. These decisions are routed to the appropriate session managers through a messaging fabric, which allows each it to reconfigure their underlying sub-systems accordingly. Additionally, the conversation manager is a programmable component so that the logic (e.g., pre-determined policies, rules, algorithms, programs, etc.) that it uses to make cross-modal decisions and determine what sessions are related to others can be specified and changed at runtime (e.g., how to precisely define a conversation and act on state changes).

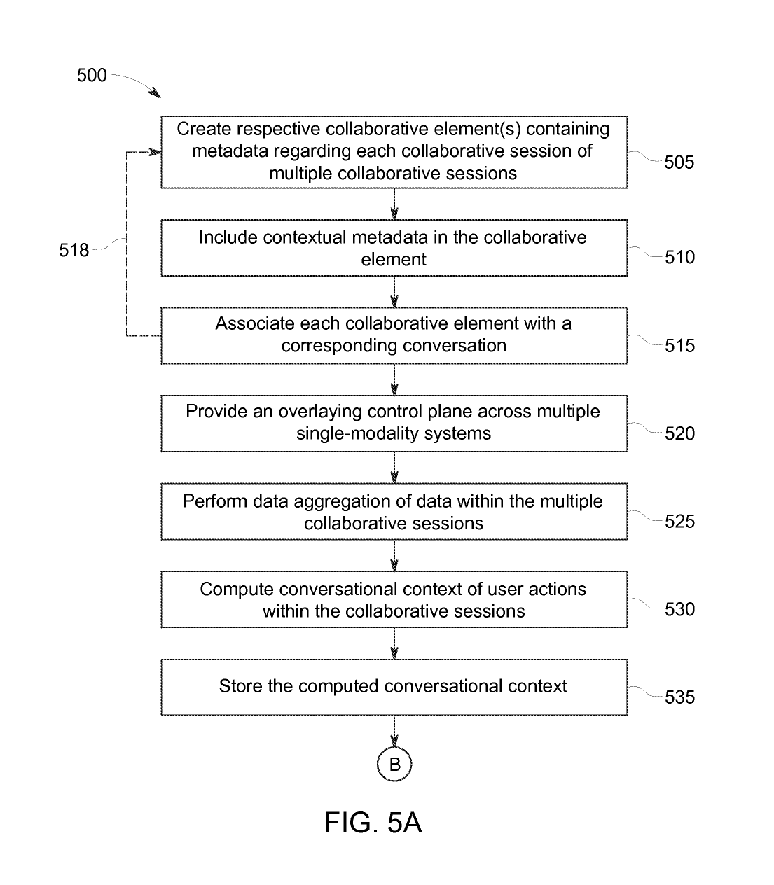

FIG. 4 depicts conversation interaction history 400 in accordance with some embodiments. Conversation interaction history 400 can be a scenario with evolving participants, modalities, and goals. From the field, Field engineer 405 might begin addressing a complex customer (client) problem by engaging with remote experts 410, 412 through an instant messaging modality. Experts 410, 412 may themselves privately confer with one another using audio phone call modality while the field engineer continues to interact with them solely through messages.

At some point, expert 410 may reach out to field engineer 405 through videoconferencing modality to see exactly what is going on in the field. This may escalate to other modalities between the field engineer and remote expert, such as image annotation modality, as the group tries to determine an appropriate and cost-effective solution to the problem on site. Finally, the field engineer could contact customer 420 via an audio call modality to ensure that they are satisfied with the resolution.

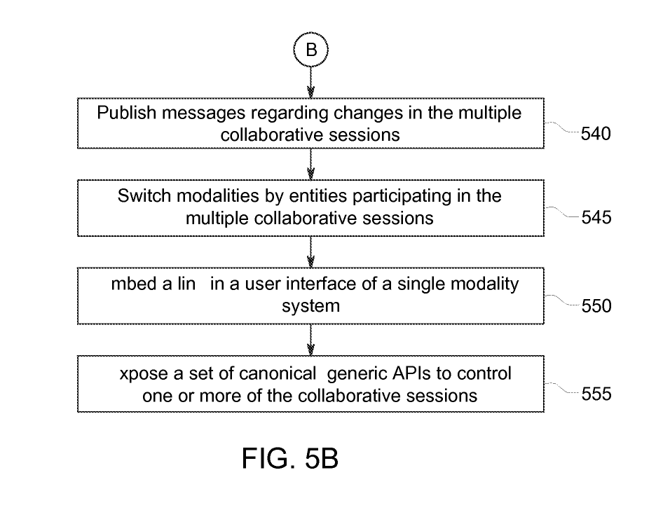

FIGS. 5A-5B depict process 500 for correlating multiple collaborative sessions occurring on multiple single-modality systems in accordance with some embodiments. In accordance with embodiments, one or more collaborative elements containing metadata about each respective collaborative session can be created, step 505. In some implementations the collaborative element(s) can include, step 510, contextual metadata regarding a relationship between two or more corresponding conversations of the collaborative sessions. Each collaborative element can be associated, step 515, with a corresponding conversation of the multiple collaborative sessions. In accordance with embodiments, an additional collaborative session can be conducted among the participants. This additional collaborative session can have a respective collaborative session created. To achieve this, process 500 can proceed back to step 505 (as indicated by arrow 518). Accordingly, process 500 need not be a linear process. Specifically, additional sessions can be associated with a conversational context at any time—and not just from step 515.

A control plane overlaying across the multiple single-modality systems can be provided, step 520. In some implementations, this overlaying control plane can perform data aggregation, step 525, of data within the multiple collaborative sessions.

Conversational context of user actions within one or more of the multiple collaborative sessions can be computed, step 530. The conversational contexts can be stored, step 535, in a connected data store by the overlaying control plane. One or more messages providing information regarding changes in the multiple collaborative sessions can be published, step 540. The changes to the multiple collaborative sessions can occur over a time period. Entities participating in one or more of the multiple collaborative sessions can switch modalities, step 545. Because the multiple collaborative sessions have been correlated, the entities can follow session conversations by accessing the published one or more messages.

A link can be embedded, step 550, in at least one user interface of one of the single-modality systems. The link can refer to a previous session having a set of participants that is an identical set of participants as a current session. A set of canonical generic application programming interfaces (API) can be exposed, step 555. These APIs can be configured to control one or more of the multiple collaborative sessions.

By way of example, the following scenario is presented for purposes of this discussion. Large, diversified, multinational conglomerate enterprises can operate in various industry verticals, including healthcare, aviation, and financial services. A common trend is the growing importance of human-in-the-loop service offerings that can supplement traditional hardware and asset-based product offerings. Collaborative technology is a critical enabler in these businesses because it allows personnel that interact with customers to tap into expertise throughout the company, solve on-site problems faster, and proactively engage customers with additional value-added services.

Business units within the multinational conglomerate can be invested in commercially-available, collaborative technologies to support these kinds of roles. However, this technology can often be fragmented across a number of proprietary vendor solutions, and is rarely embedded in the complementary enterprise applications and support tools relied on by the conglomerate's workforce. This fragmentation causes a pervasive and consistent problem across the organization—collaborative processes are opaque.

The proliferation of relatively cheap smartphones, tablets, and mobile computers has made getting access to collaborative tools at any location much easier. However as noted earlier, effectively collaborating to solve complex problems in the field often requires a suite of non-integrated tools. For example, a number of business units can rely on field engineers to service assets at customer locations, like hospitals and power plants. These engineers do have access to various formal case management tools to get support in the field, and these systems play an important role in documenting customer problems, the subsequent actions that were taken, and creating a chain of responsibility. Nonetheless, before, during, and after cases are formally created information is often exchanged via phone calls, photo sharing applications, or through other single-modality systems suited to the immediate problem and tasks at hand. Embodying systems and methods are not so limited, and it should be understood that other scenarios, modalities, sequences, and participants are within the scope of this disclosure.

In such scenarios referring to or moving data from one system to another can be burdensome. Unfortunately, this problem fundamentally cannot be solved by tight systems-level integration. The tools and software applications that are employed throughout the process are simply too variable. But more importantly, it is not just the movement of data from one system to another that is problematic.

Visibility into the problem solving process can also be desirable. For example, supervision/management/quality assurance/etc. could want access to information regarding whether progress is being made and whether the relevant people are aware of the situation. In conventional systems such information is rarely available because the data that is being generated during the collaborative problem solving process is scattered across a variety of tools and there is no obvious means to correlate it. An embodying conversation-based system can help expose this data, make it visible, and even enable the use of data-driven techniques to proactively identify abnormal or atypical situations as conversations emerge through the raw data.

Embodying conversation-based system include a common meta-model that is exposed through the conversation manager component. This meta-model provides a mechanism to build software tools that share some common contextual data. For instance, applications built on the conversation-based system can detect if a user is engaged in any session at any point in time, regardless of whether or not it is the same application. Similarly, it allows applications to pull content from one session into another session in another application, such as images and documents that may be used across various applications (i.e., modalities) as the conversation evolves.

Embodying conversation-based architectures can make the dynamic, ad-hoc, and articulated process of collaboration more visible. Applications are built that are not tightly integrated at a functional level, but are integrated enough so that the visibility of a conversation is not lost when it changes modalities and purposes.

Developers implement this mechanism by building applications that “tag” sessions (see Table 1) with conversations, and other arbitrary metadata, such that the conversation-based system's essential collaborative services are invoked during these sessions are explicitly bound together into logical conversations. Hence, once an application determines what conversation it is currently being used in it can pass this piece of information along so that other supported modalities and subsequently used applications can also refer to it.

Embodying conversation-based systems and methods employ a loosely coupled integration architecture, instead of a pre-defined activity structure, to organize the collaborative applications around the constructs of “conversations” and “sessions.” This affords a more flexible and reconfigurable environment to meet dynamically changing requirements, without losing track of users actions over time. In addition, it provides an extensible and dynamic mechanism for specifying how the behavior of the sub-systems should be changed based on the observed metadata.

In accordance with embodiments, the conversation-based approach is a hybrid architecture that combines elements of service-oriented and model-based patterns. Each service defines a specific collaboration modality that emits and consumes metadata that follows a common conversation-based schema through a loosely coupled messaging fabric. Then, at runtime, the model of conversation tracking is used to interconnect collaborative applications in a policy or rule driven manner. A conversation-based system mirrors an activity-centric computing paradigm by organizing collaborative sessions into higher-level constructs, namely as conversations. This activity-based model provides a simple, more extensible model in which to define the semantics of overall system behavior.

In accordance with some embodiments, a computer program application stored in non-volatile memory or computer-readable medium (e.g., register memory, processor cache, RAM, ROM, hard drive, flash memory, CD ROM, magnetic media, etc.) may include code or executable instructions that when executed may instruct and/or cause a controller or processor to perform methods discussed herein such as a method for correlating multiple collaborative sessions occurring on multiple single-modality systems, as described above.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and methods have been described herein, note that any number of other configurations may be provided in accordance with embodiments of the invention. Thus, while there have been shown, described, and pointed out fundamental novel features, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated.

1. A method for correlating multiple collaborative sessions occurring on multiple single-modality systems, the method comprising:
creating a respective collaborative element containing metadata about each respective collaborative session of the multiple collaborative sessions;
associating each collaborative element with a corresponding conversation of the multiple collaborative sessions;
providing an overlaying control plane across the multiple single-modality systems;
computing conversational context of user actions within one or more of the multiple collaborative sessions; and
storing computed conversational contexts by the overlaying control plane in a connected data store.

2. The method of claim 1, further including the step of including in the collaborative element contextual metadata regarding a relationship between two or more of the corresponding conversations.

3. The method of claim 1, further including performing data aggregation of data within the multiple collaborative sessions by the overlaying control plane.

4. The method of claim 1, further including publishing one or more messages providing information regarding changes in the multiple collaborative sessions, the changes occurring over a time period.

5. The method of claim 4, further including switching modalities by entities participating in one or more of the multiple collaborative sessions, wherein the entities can follow session conversations by accessing the published one or more messages.

6. The method of claim 1, further including embedding a link in at least one user interface of one of the multiple single-modality systems, the link referring to a previous session of the one of the multiple single-modality systems having a set of participants that is an identical set of participants as a current session.

7. The method of claim 1, further including exposing a set of canonical generic application programming interfaces configured to control one or more of the multiple collaborative sessions.

8. A non-transitory computer-readable medium having stored thereon instructions which when executed by a processor cause the processor to perform a method of correlating multiple collaborative sessions occurring on multiple single-modality systems, the method comprising:
creating a respective collaborative element containing metadata about each respective collaborative session of the multiple collaborative sessions;
associating each collaborative element with a corresponding conversation of the multiple collaborative sessions;
providing an overlaying control plane across the multiple single-modality systems;
computing conversational context of user actions within one or more of the multiple collaborative sessions; and
storing computed conversational contexts by the overlaying control plane in a connected data store.

9. The non-transitory computer-readable medium of claim 8, including instructions to cause the processor to perform the step of including in the collaborative element contextual metadata regarding a relationship between two or more of the corresponding conversations.

10. The non-transitory computer-readable medium of claim 8, including instructions to cause the processor to perform the step of performing data aggregation of data within the multiple collaborative sessions by the overlaying control plane.

11. The non-transitory computer-readable medium of claim 8, including instructions to cause the processor to perform the step of publishing one or more messages providing information regarding changes in the multiple collaborative sessions, the changes occurring over a time period.

12. The non-transitory computer-readable medium of claim 11, including instructions to cause the processor to perform the step of switching modalities by entities participating in one or more of the multiple collaborative sessions, wherein the entities can follow session conversations by accessing the published one or more messages.

13. The non-transitory computer-readable medium of claim 8, including instructions to cause the processor to perform the step of embedding a link in at least one user interface of one of the multiple single-modality systems, the link referring to a previous session of the one of the multiple single-modality systems having a set of participants that is an identical set of participants as a current session.

14. The non-transitory computer-readable medium of claim 8, including instructions to cause the processor to perform the step of exposing a set of canonical generic application programming interfaces configured to control one or more of the multiple collaborative sessions.

15. A system for correlating multiple collaborative sessions occurring on multiple single-modality systems, the system including:
a single-modality system configured as a set of independent single-modality sub-systems;
a multi-modal conversational system including a multi-modal conversation manager and a set of modality-specific session managers, the session managers configured to act as an overlaying control plane across the single-modality sub-systems;
the multi-modal conversation manager connected to the set of modality-specific session managers and to a conversational metadata data store; and
the multi-modal conversation manager configured to expose a contextual query interface configured to access contextual metadata within the conversational metadata data store.

16. The system of claim 15, including the modality-specific session managers configured to control a single type of modality session, the single type of modality session provided by a corresponding one of the modality-specific session managers.

17. The system of claim 15, including the modality-specific session managers including a client unified session interface (USI), an agent USI, a modality-specific interface, and a vendor adaptor.

18. The system of claim 17, including the client USI configured to expose a canonical set of generic application programming interfaces configured to control one or more of the multiple collaborative sessions.

19. The system of claim 17, including the agent USI configured to provide the session managers with life-cycle events obtained from a respective single-modality sub-systems.

20. The system of claim 17, including the modality-specific interface configured to provide an application programming interface specific to the modality of a corresponding one of the single-modality sub-systems.
